(19) United States
(12) Patent Application Publication
(10) Pub. No.: US 2013/0291691 A1
(43) Pub. Date: Nov. 7, 2013

(54) Pivoting Assembly for Hand Tool

(71) Applicant: HONG ANN TOOL INDUSTRIES CO., LTD., Taichung (TW)

(72) Inventor: Cheng-Wei Su, Taichung (TW)

(73) Assignee: Hong Ann Tool Industries Co., Ltd., Taichung (TW)

(21) Appl. No.: 13/705,243

(22) Filed: Dec. 5, 2012

(30) Foreign Application Priority Data
May 4, 2012 (TW) 101116003
Jul. 13, 2012 (TW) 101125324

(51) Int. Cl. B25B 23/00

(52) U.S. Cl. CPC B25B 23/0028; B25B 23/0021
USPC 81/177.8

(57) ABSTRACT

A pivoting assembly for a hand tool includes first and second stems pivotally connected with each other, and a positioning device. The first stem includes first and second jaw portions extending from an end thereof. An opening is formed between the first and second jaw portions. An inner periphery surface is formed between the first and second jaw portions. An aperture is extended in the inner periphery surface. The second stem includes at least one arm portions extending from an end thereof. An engaging portion is formed at an end of the arm portion. The engaging portion is engaged with the first and second jaw portions. The positioning device is received in the aperture and abutted against the engaging portion of the second stem.

### BACKGROUND OF THE INVENTION

1. Field of the Invention

The present invention relates to a pivoting assembly and, more particular, to a pivoting assembly for a hand tool foldable to a compact configuration which is excellent for applying high torque to turn objects.

2. Description of the Related Art

A conventional wrench, for example, an Allen wrench used to grip and turn or twist objects, usually rotary fasteners, such as the head of a bolt, a nut, a pipe, or the like commonly typically comprises a one-piece L-shaped metal with one end used as the driving stem and the other end used as a handle.

U.S. Pat. No. 5,943,925, Huang discloses a tool having a foldable structure. The foldable structure disclosed by Hung includes a coupler pivotally coupled between a driving stem and a handle. Applying the foldable structure to the Allen wrench, the driving stem can be folded in parallel with the handle, that is, with a zero angle relative to the handle. This results in a more compact space for storing the tool. In Huang, with respect to the handle, the driving stem can be rotated from an angle of zero degree to an angle of 180 degrees. While turning a fastener in a limited, narrow space, for example, around the boundary of two perpendicularly adjoining planes, the handle of the Allen wrench adopting the foldable structure disclosed by Huang can only be turned between zero degree to 180 degrees along a surface perpendicular to the driving stem. When a half circle of the turning action is complete, the user must disengage the Allen wrench from the fastener. By repositioning the handle to the initial point of the turning action, the turning action is repeated until the fastener is fastened as required. In other words, while tightening or untightening the fastener in a plane with a limited degree of freedom, the user may need to repeat engaging and disengaging the driving stem to reposition the handle. Moreover, using this conventional foldable structure, there is only one end of the wrench that can be used as the driving tool while the other end is used as a handle only. When a different torque is required, or the fastener with different depth is to be driven thereby, a different driving stem has to be connected and reassembled.

U.S. Pat. No. 6,443,039, Warner discloses a wrench having two driving stems pivotally connected with each other. One of the driving stems has a female fork joint protruding from a main stem with a hole at the center thereof The other driving stem has a male connecting joint protruding form the axial center of the main stem. The male joint and the female joint are engaged with each other via a connector such as a roll pin. Therefore, without using an additional hinge or other mechanical coupler, these two driving stems are pivotally connected with each other. One of these two pivotally connected driving stems flips from an angle of about 90 degrees to an angle of about 270 degrees relative to the other.

Therefore, the tool disclosed by Huang and Warner must include holes respectively formed at the two stems. Thus, a pin is inserted through the holes of the two stems to cause the two stems pivotally connected with each other. However, the holes formed at the two stems will decrease the strength of the tool to cause the tool can not apply high torque to turn objects.

The present invention is, therefore, intended to obviate or at least alleviate the problems encountered in the prior art.

### SUMMARY OF THE INVENTION

The present invention solves this need and other problems in the field of a pivoting assembly for a hand tool including first and second stems pivotally connected with each other, and a positioning device. The first stems includes a first connecting end, a first driving end spaced from the first connecting end, and first and second jaw portions respectively extending from the first connecting end. An opening is formed between distal end faces of the first and second jaw portions. An inner periphery surface is formed between the first connecting end and the first and second jaw portions. An aperture is extended in the inner periphery surface. The second stem includes a second connecting end, a second driving end spaced from the second connecting end, and at least one arm portions extending from the second connecting end. An engaging portion is formed at an end of the arm portion opposite to the second connecting end. The engaging portion includes an outer periphery surface and is engaged with the first and second jaw portions, with the outer periphery surface abutted against the inner periphery surface. The positioning device is received in the aperture and abutted against the engaging portion of the second stem.

The first driving end is spaced from the first connecting end along a first axis. Moreover, the first driving end of the first stem can drive objects and is adapted to be gripped as a handle by a user. The second driving end is spaced from the second connecting end along a second axis.

Furthermore, the first and second jaw portions respectively extend from top and bottom faces of the first connecting end along a direction parallel to the first axis and a direction parallel to a third axis.

The positioning device includes a biasing member and an engaging member. In a preferred form, the biasing member is a spring, and the engaging member is a cylindrical block.

When the second stem is pivoted relative to the first stem to cause the first and second axes being coaxial, the engaging member is engaged in the abutting recess formed at the outer periphery surface and abutted against a bottom surface of the abutting recess.

When the second stem is pivoted clockwise relative to the first stem to cause the second and third axes being coaxial, the engaging member is engaged in the abutting recess and an end face of the engaging member is firmly attached with the bottom surface of the abutting recess. Therefore, the second stem is disposed relative to the first stem with an included angle quickly.

When the second stem is pivoted counterclockwise relative to the first stem to cause the first and second axes being mutually perpendicular, the bottom face of the first connecting end of the first stem is abutted against the terminal face of the second connecting end of the second stem, with the engaging member abutted against the outer periphery surface of the engaging portion.

An advantage of the pivoting assembly for the hand tool according to the present invention is that the pivoting assembly for the hand tool includes first and second stems pivotally connected with each other without a pin to prevent forming holes for inserting the pin at the two stems to keep the strength of the pivoting assembly to cause the hand tool can apply high torque to turn objects.

Another advantage of the pivoting assembly for the hand tool according to the present invention is that the engaging portion of the second stem is engaged and received between the first and second jaw portions to cause the outer periphery surface of the engaging portion in contact with the inner periphery surface, with the outer diameter of the outer periphery surface of the engaging portion greater than the width of the opening to cause the second stem unable to disengage from the first stem.

Another advantage of the pivoting assembly for the hand tool according to the present invention is that the biasing member is abutted and biased against the engaging member to cause the engaging member engaging within the abutting recess of the second stem resulting in the second stem unable to disengage from the first stem along a direction perpendicular to the second axis.

A further advantage of the pivoting assembly for the hand tool according to the present invention is that the first and third axes form the included angle, which may be formed about zero degree to 90 degrees, and the aperture is extended along the third axis in the inner periphery surface and receiving the positioning device to cause the positioning device unable to disengage from the aperture.

The present invention will become clearer in light of the following detailed description of illustrative embodiments of this invention described in connection with the drawings.

### BRIEF DESCRIPTION OF THE DRAWINGS

The illustrative embodiments may best be described by reference to the accompanying drawings where:

FIG. 1 shows a perspective view of a pivoting assembly for a hand tool of a first embodiment according to the present invention, and illustrates first and second axes being coaxial.

FIG. 2 shows an exploded, perspective view of the pivoting assembly for the hand tool of FIG. 1.

FIG. 3 shows a cross-section view taken along line 3-3 of FIG. 1.

FIG. 4 shows a cross-section view taken along line 4-4 of FIG. 1.

FIG. 5 shows a continued, cross-section view of FIG. 3, and illustrates the first axis and a third axis being coaxial.

FIG. 6 shows a cross-section view taken along line 6-6 of FIG. 5.

FIG. 7 shows a perspective view of the pivoting assembly for the hand tool of FIG. 1, and illustrates the first axis perpendicular to the second axis.

FIG. 8 shows a partial, enlarged cross-section view of FIG. 7.

FIG. 9 shows a perspective view of a pivoting assembly for a hand tool of a second embodiment according to the present invention, and illustrates first and second axes being coaxial.

FIG. 10 shows an exploded, perspective view of the pivoting assembly for the hand tool of FIG. 9.

FIG. 11 shows a cross-section view taken along line 11-11 of FIG. 9.

FIG. 12 shows a continued, cross-section view of FIG. 11, and illustrates the first axis and a third axis being coaxial.

FIG. 13 shows a cross-section view taken along line 13-13 of FIG. 12.

FIG. 14 shows a perspective view of the pivoting assembly for the hand tool of FIG. 9, and illustrates the first axis perpendicular to the second axis.

FIG. 15 shows a partial, enlarged cross-section view of FIG. 14.

All figures are drawn for ease of explanation of the basic teachings only; the extensions of the figures with respect to number, position, relationship, and dimensions of the parts to form the illustrative embodiments will be explained or will be within the skill of the art after the following teachings have been read and understood. Further, the exact dimensions and dimensional proportions to conform to specific force, weight, strength, and similar requirements will likewise be within the skill of the art after the following teachings have been read and understood.

Where used in the various figures of the drawings, the same numerals designate the same or similar parts. Furthermore, when the terms “first”, “second”, “third”, “fourth”, “end”, “portion”, “longitudinal”, “radial”, “diameter”, “width”, “thickness”, and similar terms are used herein, it should be understood that these terms have reference only to the structure shown in the drawings as it would appear to a person viewing the drawings and are utilized only to facilitate describing the illustrative embodiments.

### DETAILED DESCRIPTION OF THE PREFERRED EMBODIMENTS

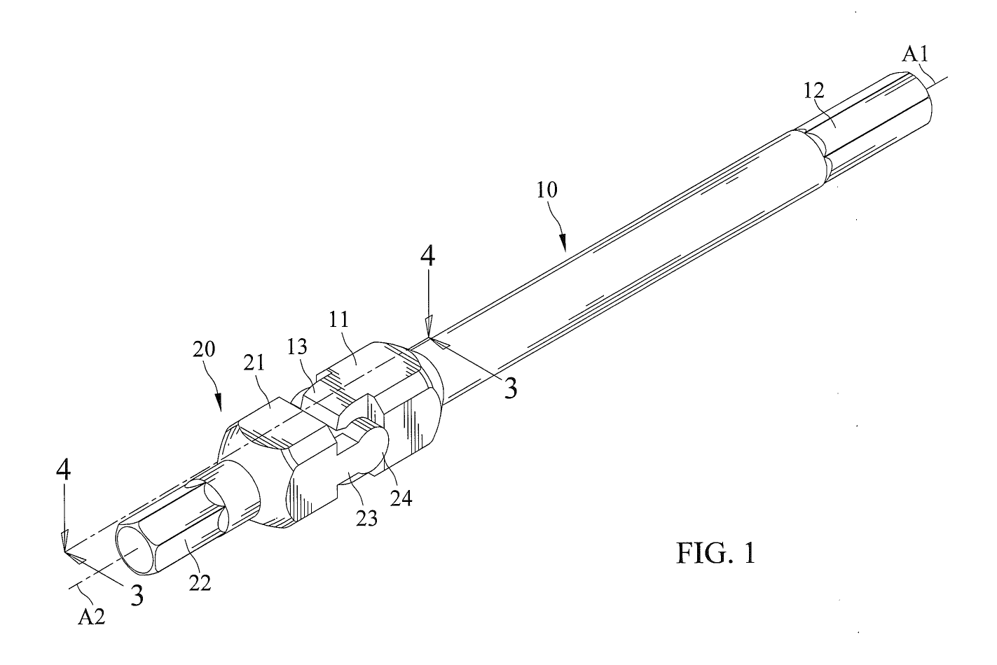

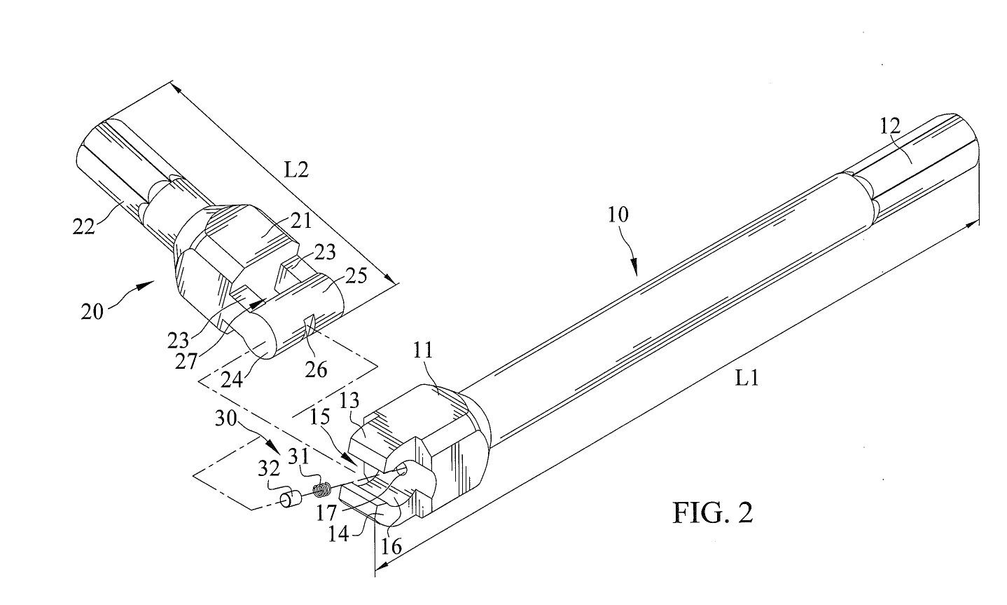

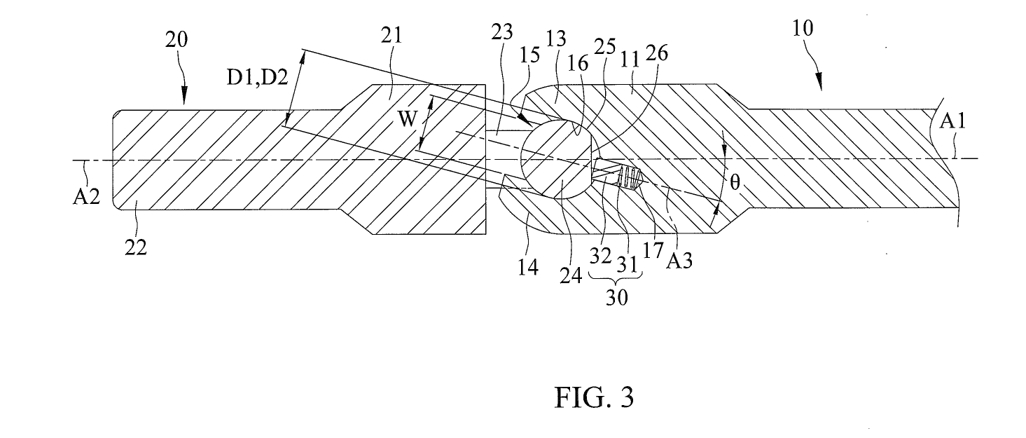

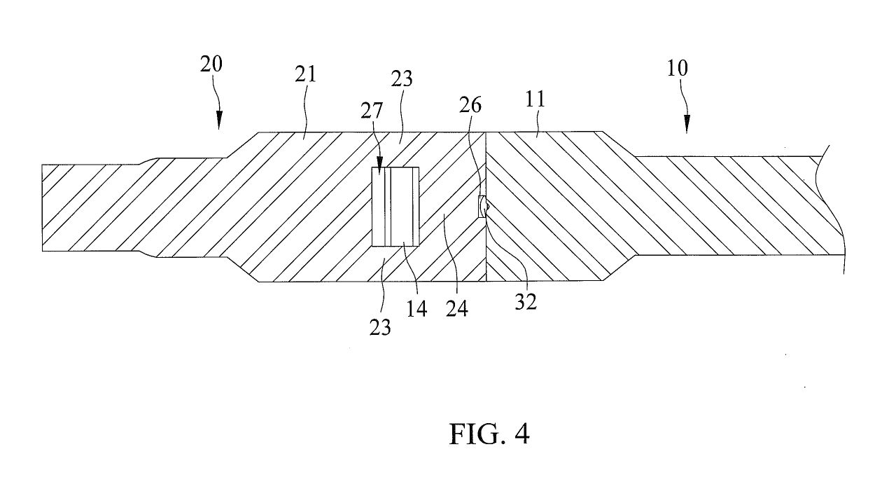

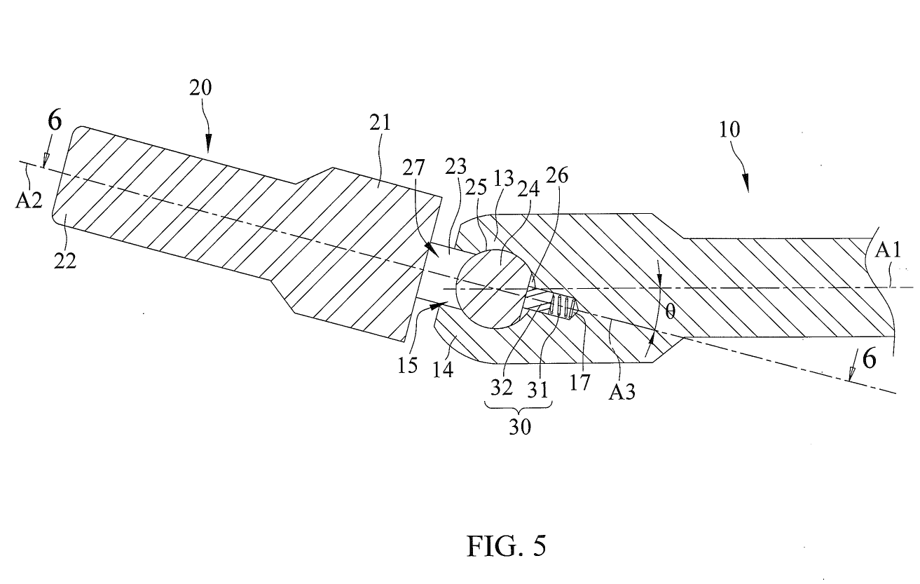

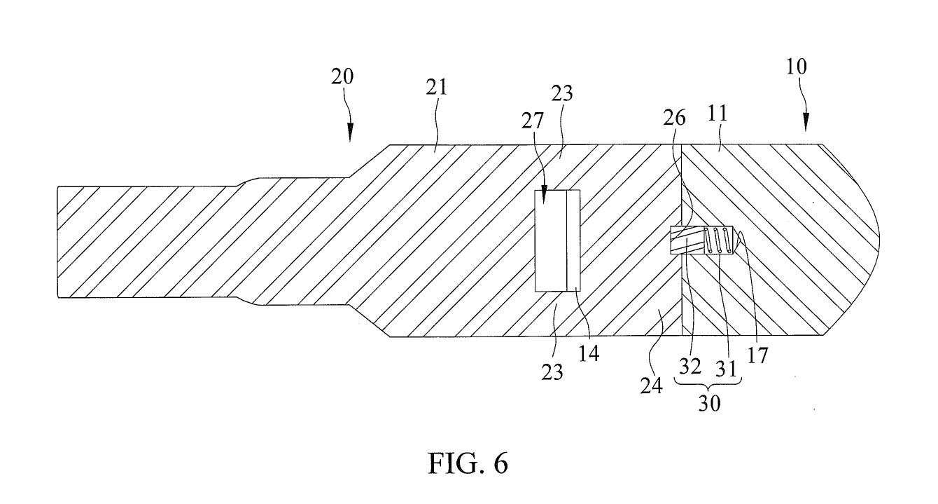

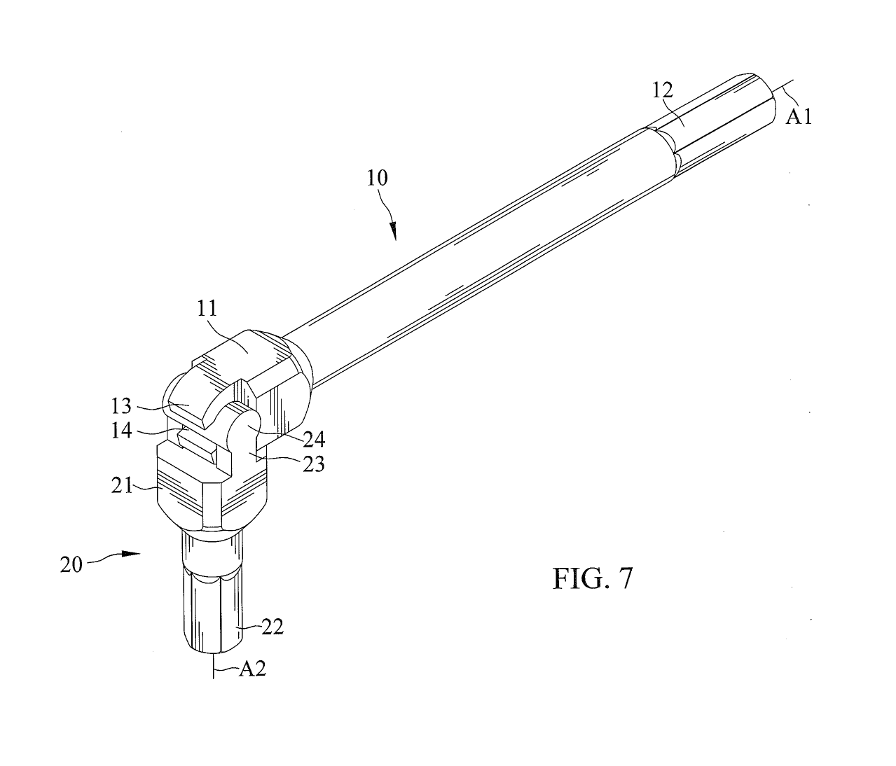

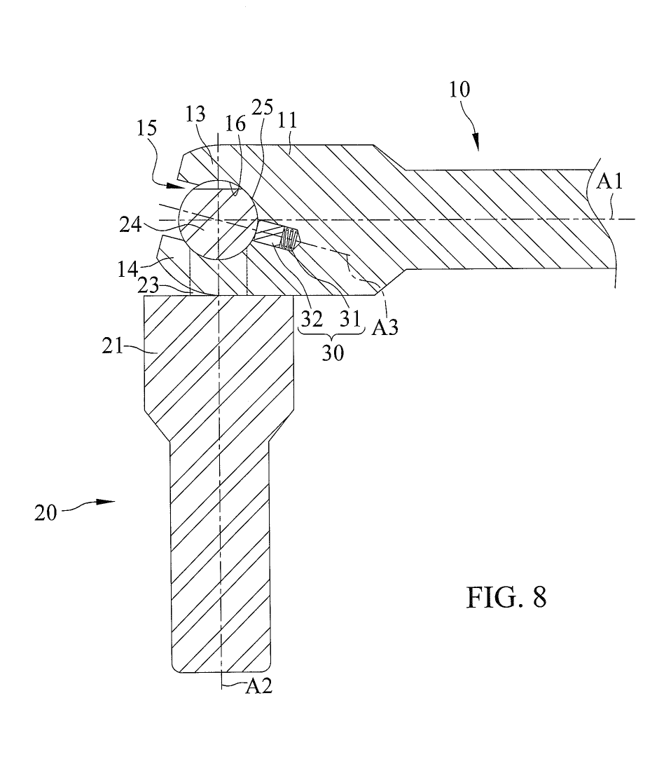

FIGS. 1 through 8 show a first embodiment of a pivoting assembly for a hand tool according to the present invention shown in the drawings. The pivoting assembly for the hand tool includes first and second stems 10 and 20 pivotally connected with each other. The first stem 10 includes a first connecting end 11 and a first driving end 12 spaced from the first connecting end 11 along a first axis A1. The first driving end 12 of the first stem 10 can drive objects or is adapted to be gripped as a handle by a user. The second stem 20 includes a second connecting end 21 and a second driving end 22 spaced from the second connecting end 21 along a second axis A2. The second connecting end 21 of the second stem 20 is pivotally connected with the first connecting end 11 of the first stem 10. The second driving end 22 of the second stem 20 can drive objects or is adapted to be gripped as a handle by a user.

The first stem 10 has a first length L1 extending along the first axis A1 from the first connecting end 11 to the first driving end 12 thereof. Moreover, the first stem 10 includes first and second jaw portions 13 and 14 respectively extending from top and bottom faces of the first connecting end 11 along a direction parallel to the first axis A1 and a direction parallel to a third axis A3. An opening 15 is formed between distal end faces of the first and second jaw portions 13 and 14. Moreover, distal ends of the first and second jaw portions 13 and 14 adjacent to the opening 15 are respectively extended partially toward the first axis A1 and the third axis A3. The first and third axes A1 and A3 form an included angle θ, which may be formed about zero degree to 90 degrees. The opening 15 has a width W formed between the distal end faces of the first and second jaw portions 13 and 14. An inner periphery surface 16 is formed between a terminal face of the first connecting end 11 and the first and second jaw portions 13 and 14. The inner periphery surface 16 is connected with the opening 15 and has an arched surface, and an inner diameter D1 defined therein. The inner diameter D1 is greater than the width W. An aperture 17 is extended along the third axis A3 in the inner periphery surface 16. A positioning device 30 is received in the aperture 17 and includes a biasing member 31 and an engaging member 32. In a preferred form, the biasing member 31 is a spring, and the engaging member 32 is a cylindrical block.

The second stem 20 has a second length L2 extending along the second axis A2 from the second connecting end 21 to the second driving end 22 thereof. Additionally, the second length L2 of the second stem 20 is less than the first length L1 of the first stem 10. Moreover, the second stem 20 includes two arm portions 23 respectively extending from two opposite end of a terminal face of the second connecting end 21 along a direction parallel to the second axis A2, and an engaging portion 24 formed between distal ends of the two arm portions 23 opposite to the terminal face of the second connecting end 21. The engaging portion 24 has a columnar cross section parallel to the second axis A2, and includes an outer periphery surface 25 having an outer diameter D2 equal to the inner diameter D1 of the inner periphery surface 16. The engaging portion 24 further includes an abutting recess 26 formed at the outer periphery surface 25 and extended perpendicularly to the second axis A2. A gap 27 is formed between the two arm portions 23 and the engaging portion 24. The gap 27 is adapted for receiving the first and second jaw portions 13 and 14. The engaging portion 24 of the second stem 20 is engaged and received between the first and second jaw portions 13 and 14. The outer periphery surface 25 of the engaging portion 24 is in contact with the inner periphery surface 16. Therefore, the second stem 20 is pivotally connected with the first stem 10. Moreover, the outer diameter D2 of the outer periphery surface 25 is greater than the width W of the opening 15 to cause the second stem 20 unable to disengage from the first stem 10 along the second axis A2.

The biasing member 31 is abutting and biasing against the engaging member 32 to cause the engaging member 32 engaging within the abutting recess 26 of the second stem 20 resulting in the second stem 20 unable to disengage from the first stem 10 along a direction perpendicular to the second axis A2.

When the second stem 20 is pivoted relative to the first stem 10 to cause the first and second axes A1 and A2 being coaxial, the engaging member 32 is engaged in the abutting recess 26 and abutted against a bottom surface of the abutting recess 26, with the second jaw portion 14 received into the gap 27.

When the second stem 20 is pivoted clockwise relative to the first stem 10 with the included angle θ to cause the second and third axes A2 and A3 being coaxial, the engaging member 32 is engaged in the abutting recess 26 and an end face of the engaging member 32 is firmly attached with the bottom surface of the abutting recess 26. Therefore, the second stem 20 is disposed relative to the first stem 10 with the included angle θ quickly. In the meantime, the second jaw portion 14 escapes from the gap 27.

When the second stem 20 is pivoted counterclockwise relative to the first stem 10 to cause the first and second axes A1 and A2 being mutually perpendicular, the bottom face of the first connecting end 11 of the first stem 10 is abutted against the terminal face of the second connecting end 21 of the second stem 20, with the second jaw portion 14 passing through the gap 27, with the engaging member 32 abutted against the outer periphery surface 25 of the engaging portion 24.

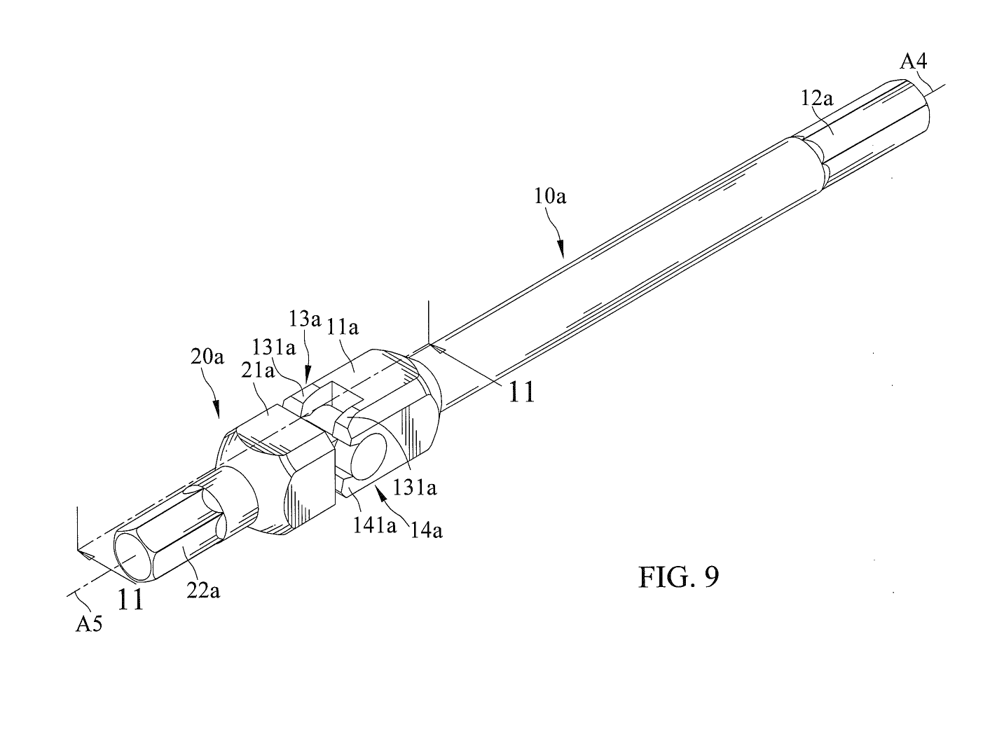

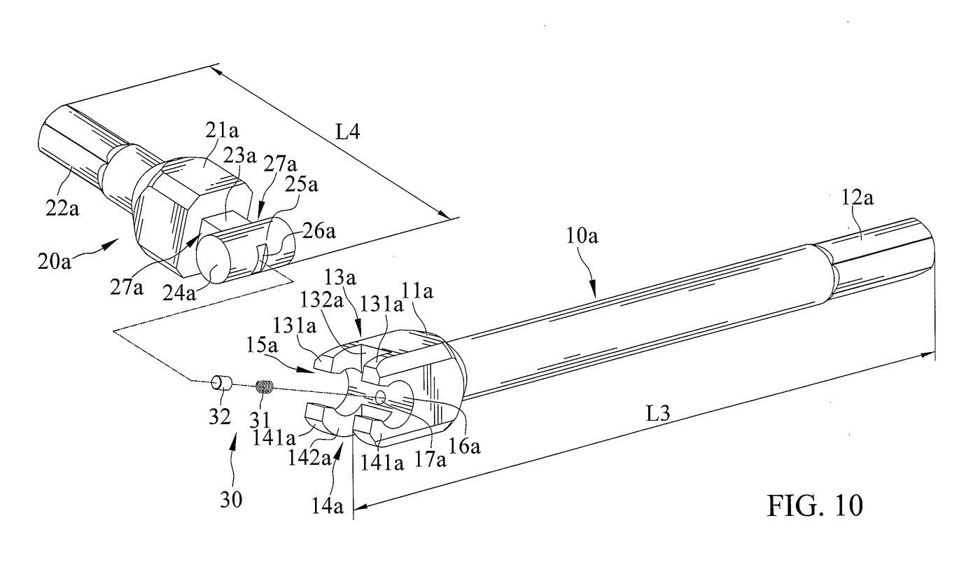

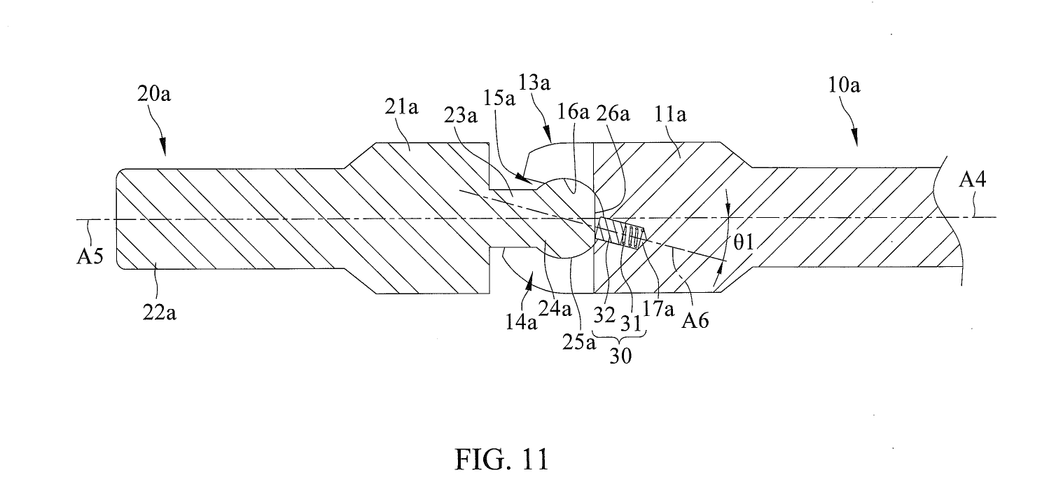

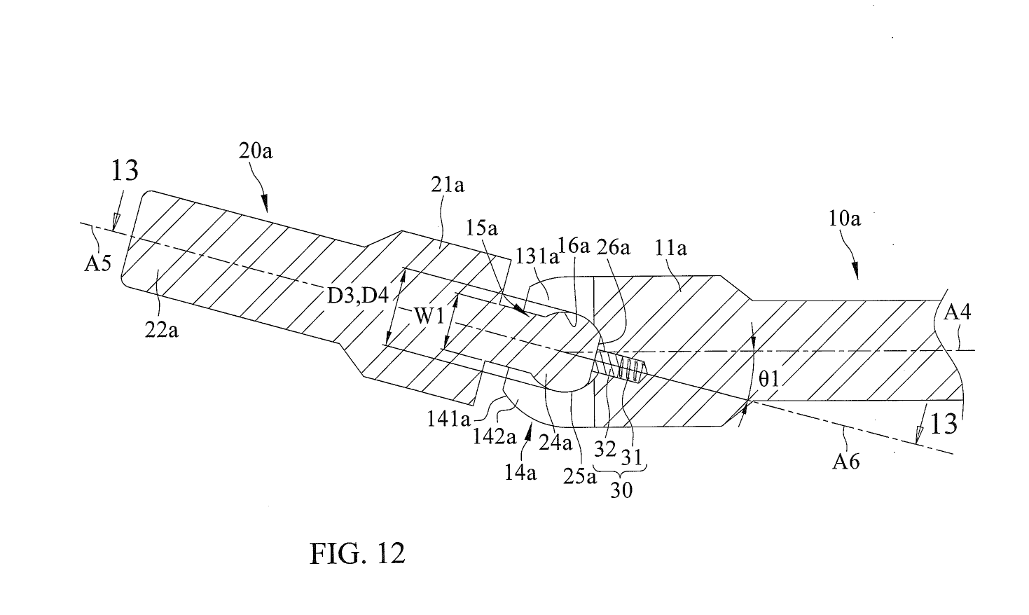

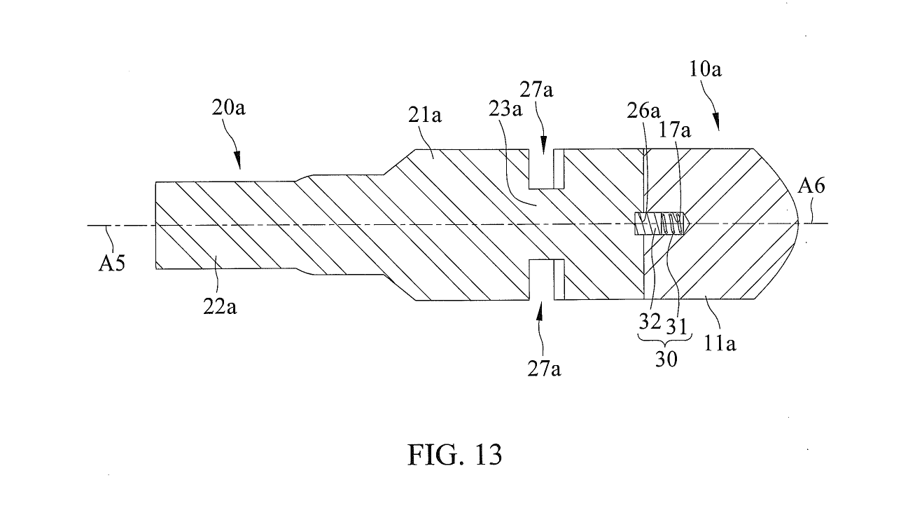

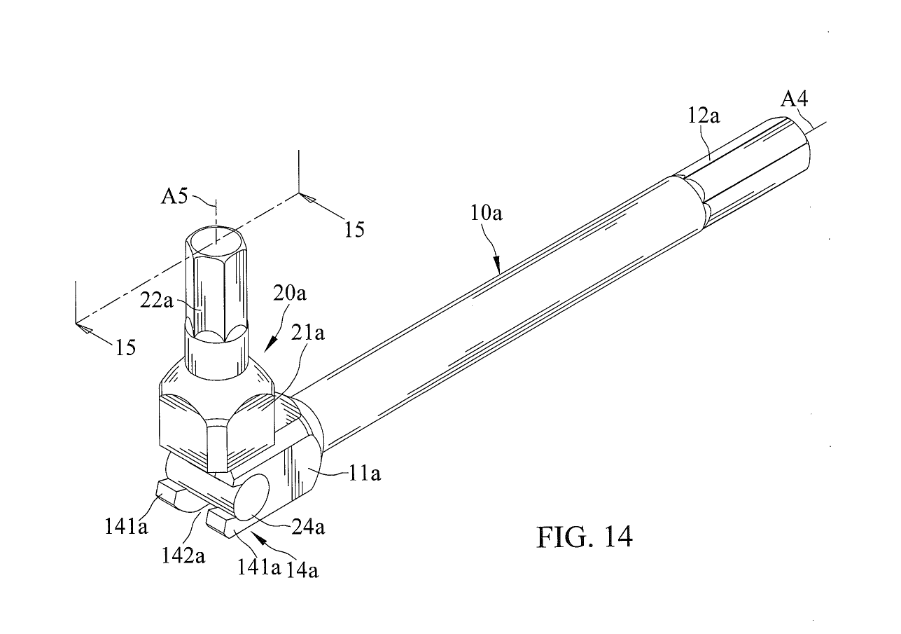

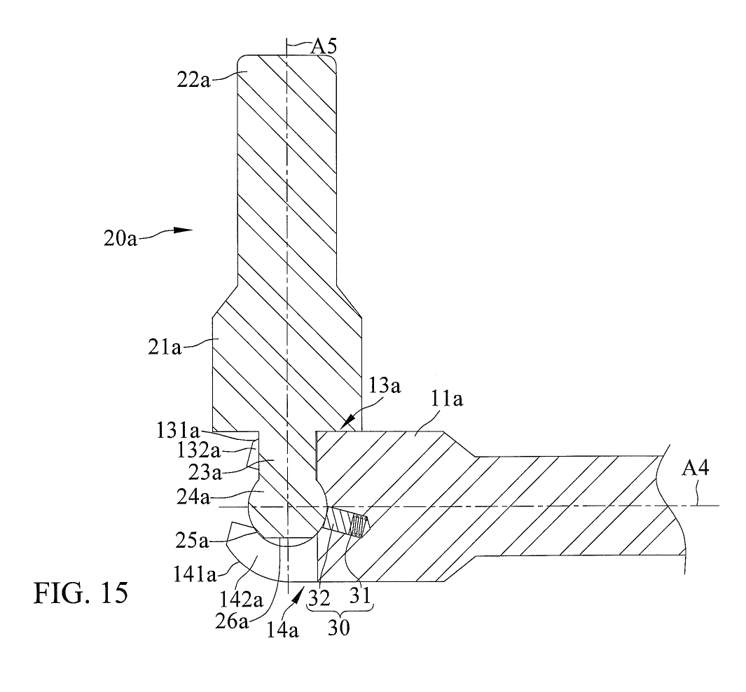

FIGS. 9 through 15 show a second embodiment of the pivoting assembly for the hand tool according to the present invention shown in the drawings, wherein the like numerals are utilized to denote similar elements of the first embodiment, however, bearing a suffix “a”. Specifically, the first stem 10a has the first length L3 extending along the first axis A4 from the first connecting end 11a to the first driving end 12a thereof. Moreover, the first stem 10a includes first and second jaw portions 13a and 14a respectively extending from top and bottom faces of the first connecting end 11a along a direction parallel to the first axis A4 and a direction parallel to a third axis A6. The first and third axes A4 and A6 form an included angle θ1, which may be formed about zero degree to 90 degrees. The first jaw portion 13a includes two first extending sections 131a and a first slot 132a formed between the two first extending sections 131a. The second jaw portion 14a includes two second extending sections 141a formed corresponding to the two first extending sections 131a, and a second slot 142a formed between the two second extending sections 141a. Moreover, distal ends of the two first extending sections 131a of the first jaw portion 13 and distal ends of the two second extending sections 141a of the second jaw portion 14a are respectively extended partially toward the first axis A4. An opening 15a is formed between distal end faces of the first and second jaw portions 13a and 14a and connected and in communication with the first and second slots 132a and 142a.

The opening 15a has a width W1 formed between the distal end faces of the first and second jaw portions 13a and 14a. An inner periphery surface 16a is formed between the terminal face of the first connecting end 11a and the first and second jaw portions 13a and 14a. The inner periphery surface 16a is connected with the opening 15a and has an arched surface, and the inner diameter D3 defined therein. The inner diameter D3 is greater than the width W1. An aperture 17a is extended along the third axis A6 in the inner periphery surface 16a. The positioning device 30 is received in the aperture 17a.

The second stem 20a has the second length L4 extending along the second axis A5 from the second connecting end 21 a to the second driving end 22a thereof Additionally, the second length L4 of the second stem 20a is less than the first length L3 of the first stem 10a. Moreover, the second stem 20a includes the arm portions 23a extending from the terminal face of the second connecting end 21a along the second axis A5, and an engaging portion 24a formed at the distal end of the arm portions 23a opposite to the terminal face of the second connecting end 21a and extended perpendicularly to the second axis A5. The first and second slots 132a and 142a are adapted for receiving the arm portions 23a. The engaging portion 24a has a columnar cross section parallel to the second axis A5, and includes an outer periphery surface 25a having the outer diameter D4 equal to the inner diameter D3, and an abutting recess 26a formed at the outer periphery surface 25a and extended perpendicularly to the second axis A5. Two gaps 27a are respectively formed between the terminal face of the second connecting end 21a, two side faces of the arm portions 23a, and the outer periphery surface 25a of the engaging portion 24a.

The engaging portion 24a of the second stem 20a is engaged and received between the first and second jaw portions 13a and 14a. The outer periphery surface 25a of the engaging portion 24a is in contact with the inner periphery surface 16a. Therefore, the second stem 20a is pivotally connected with the first stem 10a.

The biasing member 31 is abutted and biased against the engaging member 32 to cause the engaging member 32 engaging within the abutting recess 26a of the second stem 20a resulting in the second stem 20a unable to disengage from the first stem 10a along the direction perpendicular to the second axis A5.

When the second stem 20a is pivoted relative to the first stem 10a to cause the first and second axes A4 and A5 being coaxial, the engaging member 32 is engaged in the abutting recess 26a and abutted against a bottom surface of the abutting recess 26a, with the two second extending sections 141a of the second jaw portion 14a received into the two gaps 27a, with the arm portion 23a received into the second slot 142a of the second jaw portion 14a.

When the second stem 20a is pivoted clockwise relative to the first stem 10a with the included angle θ1 to cause the second and third axes A5 and A6 being coaxial, the engaging member 32 is engaged in the abutting recess 26a and the end face of the engaging member 32 is firmly attached with the bottom surface of the abutting recess 26a. Therefore, the second stem 20a is disposed relative to the first stem 10a with the included angle θ1 quickly. In the meantime, the two second extending sections 141a of the second jaw portion 14a and the arm portion 23a respectively escape from the two gaps 27a and the second slot 142a of the second jaw portion 14a.

When the second stem 20a is sequentially pivoted clockwise relative to the first stem 10a to cause the first and second axes A4 and A5 being mutually perpendicular, the top face of the first connecting end 11a of the first stem 10a is abutted against the terminal face of the second connecting end 21a of the second stem 20a, with the two second extending sections 141a of the second jaw portion 14a escaping from the two gaps 27a, with the arm portion 23a received into the first slot 132a of the first jaw portion 13a, with the engaging member 32 abutted against the outer periphery surface 25a of the engaging portion 24a.

The pivoting assembly for the hand tool includes the following advantages:

1. The pivoting assembly for the hand tool includes first and second stems 10, 10a, 20, and 20a pivotally connected with each other without a pin to prevent forming holes for inserting the pin at the two stems 10, 20, 10a, and 20a to keep the strength of the pivoting assembly to cause the hand tool can apply high torque to turn objects.

2. The engaging portion 24 and 24a of the second stem 20 and 20a is engaged and received between the first and second jaw portions 13, 14, 13a, and 14a to cause the outer periphery surface 25 and 25a of the engaging portion 24 and 24a in contact with the inner periphery surface 16 and 16a. Moreover, the outer diameter D2 and D4 of the outer periphery surface 25 and 25a of the engaging portion 24 and 24a is greater than the width W and W1 of the opening 15 and 15a to cause the second stem 20 and 20a unable to disengage from the first stem 10 and 10a.

3. The biasing member 31 is abutted and biased against the engaging member 32 to cause the engaging member 32 engaging within the abutting recess 26 and 26a of the second stem 20 and 20a resulting in the second stem 20 and 20a unable to disengage from the first stem 10 and 10a along a direction perpendicular to the second axis A2 and A5.

4. The first and third axes A1, A4, A3, and A6 form the included angle θ and θ1, which may be formed about zero degree to 90 degrees, and the aperture 17 and 17a is extended along the third axis A3 and A6 in the inner periphery surface 16 and 16a and receiving the positioning device 30 to cause the positioning device 30 unable to disengage from the aperture 17 and 17a.

Thus since the illustrative embodiments disclosed herein may be embodied in other specific forms without departing from the spirit or general characteristics thereof, some of which forms have been indicated, the embodiments described herein are to be considered in all respects illustrative and not restrictive. The scope is to be indicated by the appended claims, rather than by the foregoing description, and all changes which come within the meaning and range of equivalency of the claims are intended to be embraced therein.

What is claimed is:

1. A pivoting assembly for a hand tool comprising:
a first stem including a first connecting end, a first driving end spaced from the first connecting end, and first and second jaw portions respectively extending from the first connecting end, with a opening formed between distal end faces of the first and second jaw portions, with an inner periphery surface formed between the first connecting end and the first and second jaw portions;
a second stem pivotally connected with the first stems and including a second connecting end, a second driving end spaced from the second connecting end, and at least one arm portions extending from the second connecting end, with an engaging portion formed at an end of the arm portion opposite to the second connecting end, with the engaging portion including an outer periphery surface and engaged with the first and second jaw portions, with the outer periphery surface abutted against the inner periphery surface.

2. The pivoting assembly for the hand tool as claimed in claim 1, wherein an aperture is extended in the inner periphery surface, with a positioning device received in the aperture and abutted against the engaging portion of the second stem.

3. The pivoting assembly for the hand tool as claimed in claim 2, wherein the second stem includes two arm portions respectively extending from two opposite end of a terminal face of the second connecting end, with a gap formed between the two arm portions and the engaging portion, with the gap selectively receiving the first and second jaw portions.

4. The pivoting assembly for the hand tool as claimed in claim 3, wherein the first driving end spaced from the first connecting end along a first axis, with the second driving end spaced from the second connecting end along a second axis, with the first and second jaw portions respectively extending from top and bottom faces of the first connecting end along a direction parallel to the first axis and a direction parallel to a third axis, with the first and third axes forming an included angle.

5. The pivoting assembly for the hand tool as claimed in claim 4, wherein the included angle is formed between zero degree to 90 degrees.

6. The pivoting assembly for the hand tool as claimed in claim 4, wherein the engaging portion includes an abutting recess formed at the outer periphery surface and extended perpendicularly to the second axis, wherein the positioning device includes a biasing member and an engaging member, with the biasing member abutting and biasing against the engaging member, with the engaging member selectively engaging in the abutting recess of the second stem.

7. The pivoting assembly for the hand tool as claimed in claim 6, wherein when the second stem is pivoted relative to the first stem to cause the first and second axes being coaxial, with the engaging member engaged in the abutting recess and abutted against a bottom surface of the abutting recess, with the second jaw portion received into the gap.

8. The pivoting assembly for the hand tool as claimed in claim 6, wherein when the second stem is pivoted relative to the first stem to cause the second and third axes being coaxial, with the engaging member engaged in the abutting recess and an end face of the engaging member firmly attached with a bottom surface of the abutting recess, with the second jaw portion escaping from the gap.

9. The pivoting assembly for the hand tool as claimed in claim 6, wherein when the second stem is pivoted relative to the first stem to cause the first and second axes being mutually perpendicular, with the bottom face of the first connecting end of the first stem abutted against the terminal face of the second connecting end of the second stem, with the second jaw portion passing through the gap, with the engaging member abutted against the outer periphery surface of the engaging portion.

10. The pivoting assembly for the hand tool as claimed in claim 2, wherein the second stem includes an arm portions extending from a terminal face of the second connecting end, with two gaps respectively formed between the terminal face of the second connecting end, two side faces of the arm portions, and the outer periphery surface of the engaging portion, with the gap selectively receiving the first and second jaw portions.

11. The pivoting assembly for the hand tool as claimed in claim 10, wherein the first driving end spaced from the first connecting end along a first axis, with the second driving end spaced from the second connecting end along a second axis, with the first and second jaw portions respectively extending from top and bottom faces of the first connecting end along a direction parallel to the first axis and a direction parallel to a third axis, with the first and third axes forming an included angle.

12. The pivoting assembly for the hand tool as claimed in claim 11, wherein the first jaw portion includes two first extending sections and a first slot formed between the two first extending sections, wherein the second jaw portion includes two second extending sections formed corresponding to the two first extending sections, and a second slot formed between the two second extending sections, with the first and second slots selectively receiving the arm portions.

13. The pivoting assembly for the hand tool as claimed in claim 12, wherein the engaging portion includes an abutting recess formed at the outer periphery surface and extended perpendicularly to the second axis, wherein the positioning device includes a biasing member and an engaging member, with the biasing member abutting and biasing against the engaging member, with the engaging member selectively engaging in the abutting recess of the second stem.

14. The pivoting assembly for the hand tool as claimed in claim 13, wherein when the second stem is pivoted relative to the first stem to cause the first and second axes being coaxial, with the engaging member engaged in the abutting recess and abutted against a bottom surface of the abutting recess, with the two second extending sections of the second jaw portion received into the two gaps, with the arm portion received into the second slot of the second jaw portion.

15. The pivoting assembly for the hand tool as claimed in claim 13, wherein when the second stem is pivoted relative to the first stem to cause the second and third axes being coaxial, with the engaging member engaged in the abutting recess and an end face of the engaging member firmly attached with a bottom surface of the abutting recess, with the two second extending sections of the second jaw portion and the arm portion respectively escape from the two gaps and the second slot of the second jaw portion.

16. The pivoting assembly for the hand tool as claimed in claim 13, wherein when the second stem is pivoted relative to the first stem to cause the first and second axes being mutually perpendicular, with the top face of the first connecting end of the first stem abutted against the terminal face of the second connecting end of the second stem, with the two second extending sections of the second jaw portion escaping from the two gaps, with the arm portion received into the first slot of the first jaw portion, with the engaging member abutted against the outer periphery surface of the engaging portion.

17. The pivoting assembly for the hand tool as claimed in claim 1, wherein the inner periphery surface is connected with the opening and has an inner diameter, wherein the outer periphery surface has an outer diameter equal to the inner diameter of the inner periphery surface, wherein the opening has a width formed between the distal end faces of the first and second jaw portions, wherein the inner diameter is greater than the width.

18. The pivoting assembly for the hand tool as claimed in claim 1, wherein the first driving end of the first stem and the second driving end of the second stem adapted for driving objects as a hand tool.

19. The pivoting assembly for the hand tool as claimed in claim 1, wherein the first driving end of the first stem and the second driving end of the second stem is adapted to be gripped as a handle by a user.

20. The pivoting assembly for the hand tool as claimed in claim 1, wherein the first stem has a first length extending along a first axis from the first connecting end to the first driving end thereof, wherein the second stem has a second length extending along a second axis from the second connecting end to the second driving end thereof, wherein the second length of the second stem is less than the first length of the first stem.
